(19) United States
(12) Patent Application Publication
(10) Pub. No.: US 2014/0297095 A1
(43) Pub. Date: Oct. 2, 2014

(54) METHOD OF MANAGING THE LIFETIME OF A STACK OF DISKS OF AN AIRCRAFT BRAKE

(71) Applicant: MESSIER-BUGATTI-DOWTY, Velizy Villacoublay (FR)

(72) Inventor: Jean-Baptiste VANEY, Velizy Villacoublay (FR)

(73) Assignee: MESSIER-BUGATTI-DOWTY, Velizy Villacoublay (FR)

(21) Appl. No.: 14/224,794

(22) Filed: Mar. 25, 2014

(30) Foreign Application Priority Data
Mar. 27, 2013 (FR) 13 52784

(51) Int. Cl. B60T 17/22; B64C 25/42

(52) U.S. Cl. CPC B60T 17/22; B64C 25/42
USPC 701/29.4

(57) ABSTRACT

A method of managing the lifetime of a stack of disks of an aircraft brake having at least one braking actuator including a pusher adapted to press selectively against the stack of disks in order to generate a braking force for an associated wheel, the method comprising the following steps, for a given flight of the aircraft:
actuating the actuator to cause the pusher to come into contact with the stack of disks;
deducing therefrom a stroke of the actuator, and by taking the difference with a nominal stroke stored in memory corresponding to the stack of disks when new, deducing a current level of wear (U) for the stack of disks;
from the current level of wear and from the number of flights (N) flown since the new stack of disks was mounted, using an extrapolation method to estimate a potential number of flights (ΔN) before the stack of disks reaches a maximum acceptable level of wear (Uₘₐₓ).

The invention relates to a method of managing the lifetime of a stack of disks of an aircraft brake (also referred to as a heat well).

### TECHNOLOGICAL BACKGROUND

Stacks of disks wear regularly as a result of the braking performed while the aircraft is running on the ground, both while the aircraft is landing and while it is taxiing. It is therefore necessary to change the stacks of disks regularly during the lifetime of the aircraft.

For this purpose, various methods can be envisaged. For example, it is possible to determine some number of flights beyond which the stacks of disks are changed systematically. Nevertheless, acting in that way requires certain safety margins to be taken, given the large amount of variation observed on lifetime from one stack of disks to another. That method thus leads to certain stacks of disks being changed prematurely even though they still have significant potential, and that is not economic.

Another method consists in fitting brakes with wear indicators. Maintenance crews inspect the brakes regularly in order to verify whether or not such and such a stack of disks has reached its wear limit. If it has, then the worn stack of disks is changed. That method thus requires regular inspections, and cannot provide reliable forecasts as to the potential number of flights remaining.

### OBJECT OF THE INVENTION

The invention seeks to provide a novel method of managing the lifetime of a stack of disks installed on an aircraft brake, which method obviates the above-mentioned drawbacks.

### SUMMARY OF THE INVENTION

In order to achieve this object, the invention provides a method of managing the lifetime of a stack of disks of an aircraft brake having at least one braking actuator including a pusher adapted to press selectively against the stack of disks in order to generate a braking force for an associated wheel, the method comprising the following steps, for a given flight of the aircraft:
actuating the actuator to cause the pusher to come into contact with the stack of disks;
deducing therefrom a stroke of the actuator, and by taking the difference with a nominal stroke stored in memory corresponding to the stack of disks when new, deducing a level of wear U for the stack of disks;
from the level of wear U and from the number of flights N flown since the new stack of disks was mounted, using an extrapolation method to estimate a potential number of flights ΔN before the stack of disks reaches a maximum acceptable level of wear Uₘₐₓ.

Thus, by measuring the actual wear and extrapolating, a potential number of flights for which the stack of disks can continue to be used is estimated on the basis of the wear rate revealed by the measurement. This method makes it possible to avoid systematically changing a stack of disks beyond a given number of flights, which is not economic, and also makes it possible to track the wear of the stack of disks without requiring action on the part of a maintenance crew.

Furthermore, the potential number of flights as estimated in this way can not only be forwarded to the pilot, but can also be sent to a maintenance center that manages the maintenance of the aircraft (preferably automatically), thereby enabling it to program accurately when the stack of brake disks of each brake is to be changed, thus making it possible to optimize orders for disk stacks (and thus to optimize their production).

The estimation portion of the calculation in the method of the invention is preferably installed in the braking computer that manages the brakes, or if the brake is electromechanical, in one of the electromechanical actuator controllers (EMACs) connected to the brake.

In a preferred implementation of the invention, the extrapolation comprises using a given wear model u=f(n), where u is the wear corresponding to the number n of flights. The operating point (U,N) acquired by the method of the invention serves to recalibrate the model of the operation of the brake in question, e.g. by a regression method. The maximum number of flights is then estimated by Nₘₐₓ=f(Uₘₐₓ). The potential number of remaining flights is then estimated by ΔN=Nₘₐₓ−N.

For example, if use is made of a model having a power law u=k.n^{α}, then the constant k of the model is given by U=K.N^{α}, such that the adapted model written with the help of the measurement is itself written: u=U.(n/N)^{α}. The maximum number of flights Nₘₐₓ corresponding to the maximum acceptable wear Uₘₐₓ is given by Nₘₐₓ=(Uₘₐₓ/U)^{1/α}.N. The potential number of flights is thus given by:

ΔNₘₐₓ−N=((Uₘₐₓ/U)^{1/α}−1).N

Under such circumstances, and preferably, all of the i measurements (Uᵢ,Nᵢ) taken since the stack of disks was mounted on the aircraft are stored in memory and used for recalibrating the model by means of a regression relating to one or more prior measurements (Uᵢ,Nᵢ).

It is then possible to perform recalibration, e.g. by means of a least squares regression. Returning to the above example, the regression in question consists in determining the parameters k, α that minimize the quantity:

ε=Σ(Uᵢ−kNᵢ^{α})²

in which the sum relates to all of the measurements that are retained for this purpose.

This recalibration may be performed each time a new measurement is taken by taking account of all of the measurements already taken that are stored in memory in order to adapt the model as closely as possible to all of the measurements. In a variant, recalibration may be performed on only the K most recent measurements (e.g. the ten most measurements), in order to take account only of the recent history of the stack of disks, which appears to be more significant than its remote pass when it comes to forecasting its lifetime.

It is also possible to perform the method of the invention only once the number of flights since the new stack of disks was mounted has reached some given quantity representative of the presumed lifetime of the stack of disks (e.g. half the excepted maximum number of flights). The method of the invention is then performed in order to obtain an operating point (U,N) on the basis of which the model is recalibrated.

Naturally, other wear models could be used.

The flight counter is naturally reset to zero each time the stack of disks is changed. For this purpose, and in a particularly advantageous implementation of the invention, the flight counter is reset to zero when the wear measured for a given flight is less than a wear measurement for a preceding flight, since this indicates that the stack of disks was changed between the two measurements. Under such circumstances, the stroke of the corresponding actuator is stored in memory in order to replace the nominal stroke that is used as the basis for estimating wear. Preferably, and in order to avoid any measurement artifacts, the flight counter is reset to zero only when the measured wear is less than wear measured during a preceding flight minus a given margin Δu. For example, the margin may be one-fourth or one-half of the maximum wear.

Thus, the flight counter is automatically reset to zero without any action being taken on the braking computer.

The method of the invention can be performed providing the braking actuator is fitted with a device for measuring the stroke of its pusher. In particular, if the actuator is of the electromechanical type with an electric motor and a transmission member that transforms rotation of the shaft of the motor into linear movement of the pusher, it suffices to count the number of revolutions of the motor in order to determine the stroke of the pusher. In a variant, the actuator may be fitted with a movement sensor (e.g. a sensor of the linear variable differential transformer (LVDD)) type that measures the stroke of the pusher directly.

If the brake is fitted with a plurality of actuators, it is preferable to perform the measurement of the invention using the same actuator, so that the measurements are consistent with one another. It is also possible to perform the measurement using a plurality of actuators and then to make use of the average of the measurements taken in this way. A consistency test is preferably performed in order to ignore measurements that are manifestly outliers.

1. A method of managing the lifetime of a stack of disks of an aircraft brake having at least one braking actuator including a pusher adapted to press selectively against the stack of disks in order to generate a braking force for an associated wheel, the method comprising the following steps, for a given flight of the aircraft:
actuating the actuator to cause the pusher to come into contact with the stack of disks;
deducing therefrom a stroke of the actuator, and by taking the difference with a nominal stroke stored in memory corresponding to the stack of disks when new, deducing a current level of wear (U) for the stack of disks;
from the current level of wear and from the number of flights (N) flown since the new stack of disks was mounted, using an extrapolation method to estimate a potential number of flights (ΔN) before the stack of disks reaches a maximum acceptable level of wear (Uₘₐₓ).

2. A method according to claim 1, wherein the extrapolation comprises using a wear model (u=f (n)) and includes the step of recalibrating the model on an operating point constituted by the measured level of wear and the number of flights flown (U,N), before deducing therefrom a maximum number of flights (Nₘₐₓ=f(Uₘₐₓ)), and then deducing the potential number of flights (ΔN=Nₘₐₓ−N).

3. A method according to claim 2, wherein the step of recalibrating the model takes account of one or more other measurements (Uᵢ,Nᵢ) performed earlier during preceding flights and stored in memory.

4. A method according to claim 3, wherein the recalibration takes account of a given number (K) of earlier measurements forming the most recent measurements stored in memory.

5. A method according to claim 3, wherein the model is recalibrated on each flight by taking account of all of the earlier measurements (Uᵢ,Nᵢ).

6. A method according to claim 1, wherein the potential number of flights is estimated only after flying a certain number of flights since a new stack of disks was mounted.

7. A method according to claim 1, wherein a flight number counter is reset to zero on each occasion the stack of disks is changed.

8. A method according to claim 7, wherein the flight counter is reset to zero when the level of wear measured for a given flight is less than a level of wear measured for a preceding flight.

9. A method according to claim 8, wherein the flight number counter is reset to zero only when the measured level of wear is less than a level of wear measured during a preceding flight minus a given margin (Δu).

10. A method according to claim 1, wherein the nominal stroke stored in memory is replaced by a stroke measurement performed after changing the stack of disks.
